(19) United States
(12) Patent Application Publication
(10) Pub. No.: US 2012/0276425 A1
(43) Pub. Date: Nov. 1, 2012

(54) BATTERY

(75) Inventor: Tetsuo Tokita, Tokyo (JP)

(73) Assignee: MITSUBISHI HEAVY INDUSTRIES, LTD., Tokyo (JP)

(21) Appl. No.: 13/456,551

(22) Filed: Apr. 26, 2012

(30) Foreign Application Priority Data
Apr. 28, 2011 (JP) 2011-100296

(51) Int. Cl. H01M 2/12

(52) U.S. Cl. 429/72

(57) ABSTRACT

To provide a battery that provides a simple and easy configuration to promote removal of air bubbles occurring in a stacked electrode body, and thereby improves battery performance. Provided is a battery, which includes a stacked electrode body formed by stacking a first electrode plate and a second electrode plate through a separator, an electrolytic solution or an electrolyte, a battery case that has a first electrode terminal electrically connected to the first electrode plate and a second electrode terminal electrically connected to the second electrode plate and that stores the electrolytic solution or the electrolyte and the stacked electrode body, and a squeeze section, which is located between the stacked electrode body and the battery case and formed as one body the battery case or separately from the battery case, and in which the thickness thereof is reduced toward each of a plurality of squeeze directions.

### FIELD OF THE INVENTION

The present invention relates to a battery and, in particularly, to a battery having the improved battery performance.

This application claims priority from and the benefits of Japanese Patent Application No. 2011-100296 filed on Apr. 28, 2011, the content of which is incorporated herein by reference.

### BACKGROUND ART

Batteries include primary batteries that may be only discharged, and secondary batteries that may be both charged and discharged. These batteries have a configuration in which a battery case hermetically seals a stacked electrode body together with an electrolyte. The stacked electrode is formed by stacking electrode plates, i.e. a positive plate and a negative electrode plate with a separator.

When the batteries are charged or discharged, air bubbles are typically generated in a battery case by reaction of positive electrode active materials, negative electrode active materials, or an electrolyte and so on.

When the air bubbles remain in the stacked electrode body, parts of the electrode plates of the stacked electrode body come in contact with the air bubbles and thus cannot easily contribute to ion conduction between the electrode plates. As such, there is a risk of battery performance being degraded.

For this reason, a battery in which a flow passage for the air bubbles is formed in the battery case and thus the battery performance is prevented from being degraded has been developed (see Patent Documents 1 and 2).

### PRIOR ART DOCUMENT

### Patent Document

[Patent Document 1] Japanese Unexamined Patent Application Publication No. 2003-282143
[Patent Document 2] Japanese Unexamined Patent Application Publication No. 2003-151635

### SUMMARY OF THE INVENTION

### Problems to be Solved by the Invention

However, the battery of Patent Document 1 have spacers by which the flow passage for air bubbles is formed disposed between a wall surface of the battery case and the stacked electrode body. As such, it is difficult to sufficiently remove the air bubbles generated in the stacked electrode body.

On the other hand, the battery of Patent Document 2 have glass fibers that are members forming the flow passage for air bubbles disposed in the stacked electrode body. As such, it is possible to remove the air bubbles generated in the stacked electrode body. However, since corresponding members other than the electrode plates and the separators need to be arranged in the stacked electrode body, there is a risk of the battery becoming large.

Therefore, an object of the present invention is to provide a battery that has a simple and easy structure in which the aforementioned members are not arranged in the stacked electrode body and that facilitates removal of the air bubbles generated in the stacked electrode body, thereby improving battery performance.

### Means for Solving the Problems

To accomplish the object, the present invention provides a battery, which includes a stacked electrode body formed by stacking a first electrode plate and a second electrode plate through a separator, an electrolytic solution or an electrolyte, a battery case that has a first electrode terminal electrically connected to the first electrode plate and a second electrode terminal electrically connected to the second electrode plate and that stores the electrolytic solution or the electrolyte and the stacked electrode body, and a squeeze section, which is located between the stacked electrode body and the battery case and is formed as one body the battery case or separately from the battery case, and in which a thickness thereof is reduced toward each of a plurality of squeeze directions.

That is, when the battery is charged or discharged, the stacked electrode body is expanded. However, the squeeze section is formed between the battery case and the stacked electrode body. Thereby, in line with the expansion, the air bubbles occurring in the stacked electrode body can be squeezed in a plurality of squeeze directions. That is, since the air bubbles can be prevented from remaining in the stacked electrode body by promoting floating of the air bubbles, it is possible to provide a battery representing excellent performance.

### Advantageous Effects

According to the battery of the present invention, with the simple and easy configuration, it is possible to provide the battery that promotes removal of the air bubbles occurring in the stacked electrode body, and thereby improves battery performance.

### BRIEF DESCRIPTION OF THE DRAWINGS

FIG. 1A is a schematic view of a battery of the present invention. FIG. 1A is a perspective schematic view of the front of the battery.

FIG. 1B is a schematic view of a battery of the present invention. FIG. 1B is a YZ sectional schematic view taken along line A-A′ of FIG. 1A.

FIG. 2A is a schematic view of the first auxiliary sheet 12a shown in FIG. 1A and FIG. 1B. FIG. 2A is an XZ plane schematic view showing a surface of the first auxiliary sheet that is closest to a wall surface of the first battery case.

FIG. 2B is a schematic view of the first auxiliary sheet 12a shown in FIG. 1A and FIG. 1B. FIG. 2B is an YZ plane schematic view (provided that a direction moving away from the wall surface is a +Y direction).

FIG. 3A is a schematic view showing a modification of the first auxiliary sheet 12a of FIG. 2A and FIG. 2B. FIG. 3A is an XZ plane schematic view showing a surface of the first auxiliary sheet that is closest to a wall surface of the first battery case.

FIG. 3B is a schematic view showing a modification of the first auxiliary sheet 12a of FIG. 2A and FIG. 2B. FIG. 3B is an XY plane schematic view taken along line B-B′ of FIG. 3A (provided that a direction moving away from the wall surface is a +Y direction).

FIG. 3C is a schematic view showing a modification of the first auxiliary sheet 12a of FIG. 2A and FIG. 2B. FIG. 3C is an XY plane schematic view taken along line C-C′ of FIG. 3A (provided that a direction moving away from the wall surface is a +Y direction).

FIG. 3D is a schematic view showing a modification of the first auxiliary sheet 12a of FIG. 2A and FIG. 2B. FIG. 3D is an XY plane schematic view taken along line D-D′ of FIG. 3A (provided that a direction moving away from the wall surface is a +Y direction).

FIG. 3E is a schematic view showing a modification of the first auxiliary sheet 12a of FIG. 2A and FIG. 2B. FIG. 3E is a YZ plane schematic view taken along line E-E′ of FIG. 3A (provided that a direction moving away from the wall surface is a +Y direction).

FIG. 3F is a schematic view showing a modification of the first auxiliary sheet 12a of FIG. 2A and FIG. 2B. FIG. 3F is a YZ plane schematic view taken along line F-F′ of FIG. 3A (provided that a direction moving away from the wall surface is a +Y direction).

FIG. 3G is a schematic view showing a modification of the first auxiliary sheet 12a of FIG. 2A and FIG. 2B. FIG. 3G is a YZ plane schematic view taken along line G-G′ of FIG. 3A (provided that a direction moving away from the wall surface is a +Y direction).

FIG. 4A is a schematic view showing a modification of the battery of the present invention. FIG. 4A is a perspective schematic view corresponding to FIG. 1A of the battery inserted into a protection case (second battery case).

FIG. 4B is a schematic view showing a modification of the battery of the present invention. FIG. 4B is a YZ sectional schematic view corresponding to FIG. 1B.

### BEST MODE FOR CARRYING OUT THE INVENTION

A battery according to the present invention includes a “squeeze section” to be described below which is located between a stacked electrode body and a battery case (first or second battery case to be described below) and formed as one body the battery case or separately from the battery case and in which a thickness thereof is gradually reduced with the advance in each of a plurality of “squeeze directions” to be described below. Therefore, air bubbles occurring adjacent to each electrode plate of a stacked electrode body is squeezed in any one of the plurality of squeeze directions by a volume change of the stacked electrode body associated with charge or discharge of the battery, thereby the air bubbles is floated in an acting direction of buoyancy of the air bubbles (direction opposite to the acting direction of gravity). That is, the one feature of the battery according to the present invention is that the battery has a “squeeze function” to be described below which reduces the air bubbles remaining at the electrode plates. Hereinafter, the battery of the present invention will be described with reference to the drawings.

As the battery according to embodiments to be described below and their modifications, any one of a primary battery and a secondary battery may be used. However, a description will be made herein using a chargeable battery, for instance a lithium-ion secondary battery that is a storage battery, as an example of the battery.

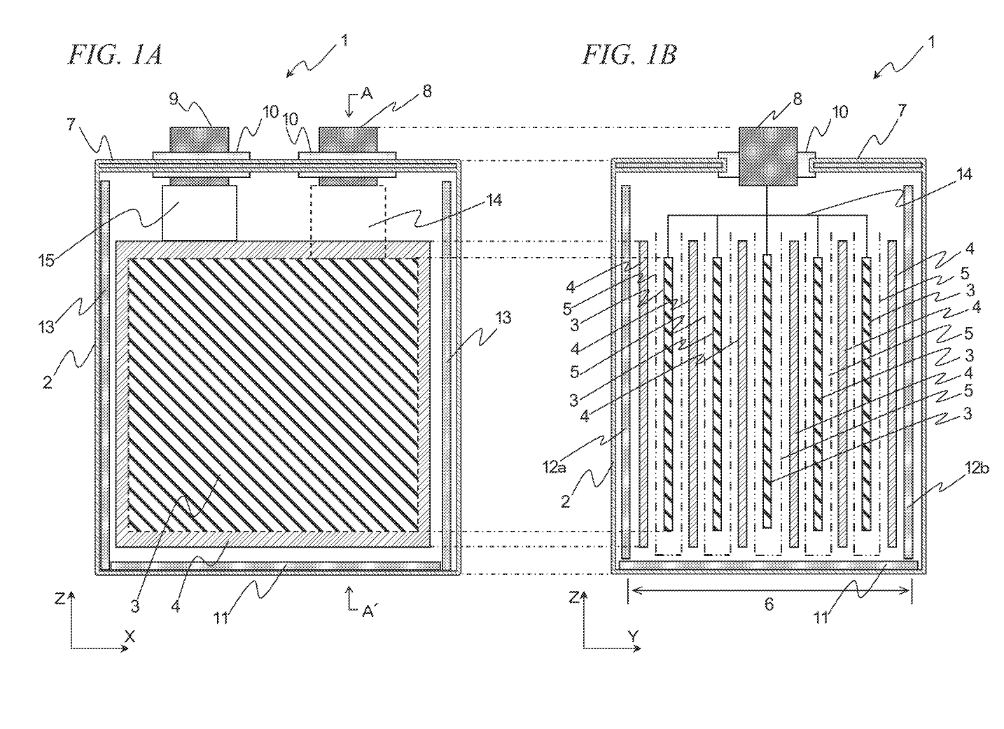

Hereinafter, a battery 1 of the present embodiment will be described with reference to FIG. 1A and FIG. 1B. First, the configuration of the battery 1 will be roughly described, and then the “squeeze function” will be described.

FIG. 1A is a perspective schematic view of the front (XZ plane) of the battery 1. FIG. 1B is a schematic sectional view taken on the YZ plane along line A-A′ of FIG. 1A. Note that all figures used below use the same orthogonal coordinate system. Further, FIG. 1A is the schematic view for promoting understanding, and thus not all of the components shown in FIG. 1B are shown in FIG. 1A.

First, the battery 1 includes; a square conductive case body 2 (e.g., formed of a metal such as an aluminum alloy) that has a bottom face with an approximately rectangular shape on the XY plane and wall surfaces extending from all sides of the approximately rectangular shape in Z direction; a stacked electrode body 6, which is stored in the case body 2, formed by stacking positive electrode plates 3 and negative electrode plates 4 through separators 5; and a cap 7 that seals the case body 2 after the stacked electrode body 6 is stored in the case body 2 (wherein the case body 2 and the cap 7 are sealed by laser welding, thereby serving as a “first battery case”). Although not shown, the first battery case is stored with an electrolytic solution or an electrolyte. A direction in which gravity acts is a −Z direction.

Here, the cap 7 has the same material as the case body 2. Thus, the cap 7 is provided with electrode terminals (a positive terminal 8 and a negative terminal 9) that are arranged to penetrate the cap 7 and is cylindrical shape (having a substantially circular with a diameter r in cross section on the XY plane), and insulating resins 10 (e.g., a plastic resin) that fix the electrode terminals to the cap 7 and electrically insulate between the electrode terminals and the cap 7.

In the embodiment as described above, as one example, the first battery case has been described as having conductivity. As such, to electrically insulate between the stacked electrode body 6 and the first battery case, an insulating resin plate 11 (e.g., a sheet formed of a plastic resin), which has substantially the same shape and dimensions as the corresponding bottom face, is arranged on an inner bottom surface of the case body 2. Further, a pair of first auxiliary sheets 12 (12a and 12b) and a pair of second auxiliary sheets 13, both of which are formed of an insulating resin to be described below, are arranged on wall surfaces other than the bottom surface of the case body 2.

In detail, the stacked electrode body 6 is sandwiched between the pair of first auxiliary sheets 12 (12a and 12b) in −Y and +Y directions, and between the pair of second auxiliary sheets 13 in −X and +X directions. These four auxiliary sheets are fixed to one another by an insulating tape, thereby forming one unit. Then, the unit is inserted into the case body 2. In this case, these auxiliary sheets can prevent the stacked electrode body 6 from being damaged by direct contact with the case body 2, and function as insertion guides for smoothly inserting the stacked electrode body into the case body 2.

The stacked electrode body 6 will be described below taking a stacked type as one example. The stacked electrode body 6 is formed by sequentially stacking a plurality of positive electrode plates 3 and a plurality of negative electrode plates 4 through separators 5.

The positive electrode plates 3 are formed by coating both surfaces of a positive electrode metal foil of, e.g., aluminum with a positive electrode active material such as lithium manganate, and by stamping the metal foil coated with the positive electrode active material in an approximately rectangular shape. In the event of this stamping, the positive electrode metal foil, on which no positive electrode active material is coated, is also integrally stamped with the positive electrode plate 3, and is connected to the positive electrode plate 3, thereby becoming a positive electrode tab 14.

On the other hand, the negative electrode plates 4 are formed by coating both surfaces of a negative electrode metal foil of, e.g., copper with a negative electrode active material such as carbon, and by stamping the metal foil coated with the negative electrode active material in an approximately rectangular shape. In the event of this stamping, the negative electrode metal foil, on which no negative electrode active material is coated, is also integrally stamped with the negative electrode plate 4, and is connected to the negative electrode plate 4, thereby becoming a negative electrode tab 15. Approximately rectangular dimensions of the negative electrode plate 4 on the XZ plane are dimensions in which it is stored in the first battery case without being bent, and approximately rectangular dimensions of the positive electrode plate 3 on the XZ plane are smaller than those of the negative electrode plate 4 on the XZ plane. Accordingly, as shown in FIG. 1A, when viewed in the Y direction, the positive electrode plate 3 is arranged within a plane of the negative electrode plate 4. Further, when the positive electrode plates 3 and the negative electrode plates 4 are stacked in the Y direction as will be described below, the negative electrode tab 15 is arranged at a position at which it does not overlap with the positive electrode tab 14 on the XZ plane.

The separator 5 may be a separator that can be used for the battery regardless of a resin separator or a ceramic separator. Here, the separator 5 is formed in the shape of a pouch, dimensions of which are designed such that an entire surface of the positive electrode plate 3 is held in the pouch, and such that the positive electrode tab 14 protrudes from the inside to the outside of the pouch.

A state in which an entire surface of the electrode plate (the positive electrode plate 3 or the negative electrode plate 4) is held in the pouched separator and in which the electrode tab (the positive electrode tab 14 or the negative electrode tab 15) protrudes from the inside to the outside of the pouch is referred to as an “internal holding”.

First, the positive electrode plate 3 surrounded by the pouched separator 5 is stacked on the negative electrode plate 4 having larger dimensions than the positive electrode plate (+Y direction), then the negative electrode plate 4 is stacked on the positive electrode plate 3 surrounded by the separator 5 (+Y direction). Here, the plurality of stacked positive electrode plates 3 are stacked in a state in which the respective positive electrode tabs 14 connected thereto are uniformly positioned on the XZ plane. Further, the plurality of stacked negative electrode plates 4 are stacked in a state in which the respective negative electrode tabs 15 connected thereto are uniformly positioned on the XZ plane.

These are sequentially repeated, and thus the stacked electrode body 6 which is made up of the plurality of positive electrode plates 3 and the plurality of negative electrode plates 4 and in which the negative electrode plates 4 are arranged at both ends thereof in the Y direction when the YZ plane is viewed in the X direction is finally formed.

When viewed in the Y direction, all the positive electrode tabs 14, which are aligned at substantially the same position, are electrically connected to the positive terminal 8 by riveting or welding. In this case, the positive electrode tabs 14 may be directly connected to the positive terminal 8, or positive electrode leads made of metal may be interposed between the positive electrode tabs 14 and the positive terminal 8. Further, when viewed in the Y direction, all the negative electrode tabs 15, which are aligned at substantially the same position, are electrically connected to the negative terminal 9 by riveting or welding. In this case, the negative electrode tabs 15 may be directly connected to the negative terminal 9, or negative electrode leads made of metal may be interposed between the negative electrode tabs 15 and the negative terminal 9.

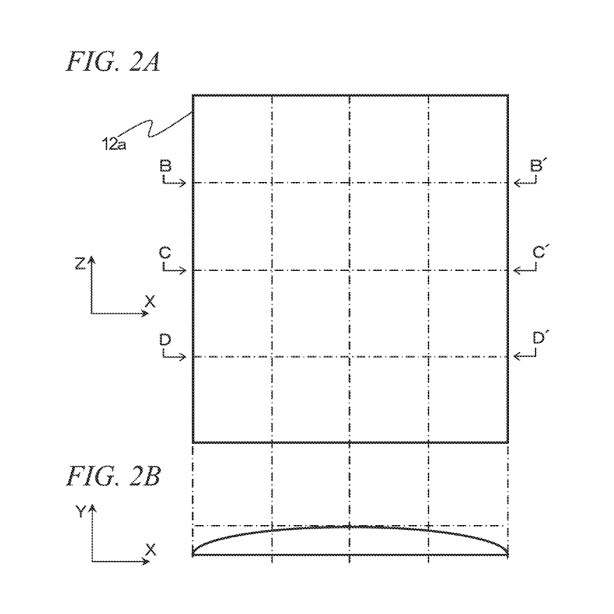

Next, the first auxiliary sheets 12 and the second auxiliary sheets 13 will be described. First, the first auxiliary sheets 12 will be described using FIG. 2A and FIG. 2B. Since all of the first auxiliary sheets 12a and 12b that are “squeeze sections” as described above are the same shape, the first auxiliary sheet 12a is representatively shown in FIG. 2A and FIG. 2B.

FIG. 2A is an XZ plane schematic view showing a surface (hereinafter referred to as “first surface”) of the first auxiliary sheet 12a that is closest to the wall surface of the first battery case. As shown in FIG. 2A, the first surface has an approximately rectangular plane. In detail, the first surface has an approximately rectangular shape, which has a width between the inner walls in the X-direction on the XZ plane of the first battery case 2 and has a length that is smaller than a length of the inner wall of the first battery case 2 in the Z-direction and that is equal to or greater than a height of the stacked electrode body 6 in the Z-direction.

Among two surfaces of the first auxiliary sheet 12a which are present in the Y direction, a surface opposite the first surface, i.e. a second surface becoming a rear surface with respect to the first surface, is designed in a shape in which air bubbles are squeezed from the vicinity of the center of the second surface toward an end of the second surface. Hereinafter, this shape is referred to as “squeeze shape.” In FIG. 2A and FIG. 2B, the “squeeze shape” is a shape in which the second surface gradually approaches the first surface with the advance from a peak of the second surface substantially-located in the center on the X axis of the second surface to the ends of ±X sides in ±X directions, i.e. a “semi-cylindrical” shape.

A direction in which the second surface gradually approaches the first surface along the squeeze shape is referred to as a “squeeze direction.” When the squeeze shape is a semi-cylindrical shape, the direction in which the second surface advances from the apex in the +X direction and the direction in which the second surface advances from the apex in the −X direction become “squeeze directions.”

In other words, the first auxiliary sheet 12a is designed so that, with the advance in the “squeeze directions,” a dimension in the Y-direction (thickness) thereof is gradually reduced. However, since the electrode plates of the stacked electrode body 6 are in contact with the second surface, the second surface is preferably formed as a substantially uniformly smooth surface with roundness and no irregularities so as not to do damage to the corresponding electrode plates. Accordingly, the apex is a shape having roundness with no angles.

Each second auxiliary sheet 13 has an approximately rectangular shape on the YZ plane of FIG. 1A and FIG. 1B. In detail, the second auxiliary sheet 13 has the approximately rectangular shape having a width between the inner walls in Y-direction on the YZ plane of the first battery case 2 and having a length that is smaller than a length of the inner wall of the first battery case 2 in the Z-direction and that is equal to or greater than a height of the stacked electrode body 6 in Z-direction.

Unlike the first auxiliary sheet 12, the second auxiliary sheet 13 has no squeeze shape, but other aspects (except for the dimensions) are similar to those of the first auxiliary sheet 12. In detail, the second auxiliary sheet 13 has two planes (front and rear surfaces) that are substantially parallel to the YZ plane of FIG. 1A and FIG. 1B. The corresponding front surface is arranged toward the wall surface of the first battery case. Further, the corresponding rear surface is arranged toward the stacked electrode body. As such, the other surface (rear surface) of the two planes is adapted to be in contact with the electrode plates of the stacked electrode body 6. Accordingly, the corresponding rear surface is preferably formed as a substantially uniformly smooth surface with no irregularities so as not to damage the electrode plates.

Now, a “squeeze function” will be described. As described above, the pair of first auxiliary sheets 12, the pair of second auxiliary sheets 13, and the stacked electrode body 6 are stored as one unit in the first battery case. Here, the two first auxiliary sheets 12 (12a and 12b) are arranged so that, of two end surfaces of the stacked electrode body 6 which are present in the stacked direction (Y direction) of the electrode plates of the stacked electrode body 6, the end surface of the −Y side is in contact with the second surface of the first auxiliary sheet 12a, and the end surface of the +Y side is in contact with the second surface of the first auxiliary sheet 12b. Further, the two second auxiliary sheets 13 are arranged so that, of two end surfaces of the stacked electrode body 6 which are present in a direction (X direction) perpendicular to a direction (+Z direction) in which the electrode tabs protrude from the electrode plates and perpendicular to the stacked direction (Y direction), the end surface of the −X side is in contact with the rear surface of one of the second auxiliary sheets 13, and the end surface of the +X side is in contact with the rear surface of the other second auxiliary sheet 13.

Then, when the battery 1 is charged and discharged, the electrolytic solution or the electrolyte is decomposed and air bubbles occur. Among the air bubbles, the finer air bubbles occurring in the stacked electrode body 6 are attached to the surfaces of the positive plates 3 and negative electrode plates 4, i.e. the surfaces of the electrode plates. When the battery 1 is arranged as shown in FIG. 1A and FIG. 1B, a buoyancy of the air bubbles acts from the bottom of the first battery case toward the cap 7 in the +Z direction that is the opposite direction to gravity. As such, a certain amount of air bubbles spontaneously rise up to the vicinity of the cap 7 in the first battery case, and remain there. However, some of the air bubbles occurring in the stacked electrode body 6 are pressed between the adjacent electrode plates, and thus cannot spontaneously rise due to the buoyancy. As a result, the air bubbles may be kept in the state attached to the surfaces of the electrode plates. In this manner, when the air bubbles remain at the surfaces of the electrode plates, the electrode plates that are in contact with the air bubbles cannot contribute to the movement of ions. As such, there is a possibility of reducing the battery performance.

Thus, to prevent the reducing of the battery performance, the battery 1 has the “squeeze function” provided by the “squeeze section”. The “squeeze function” squeezes the air bubbles attached to the surfaces of the electrode plates that do not easily rise due to the buoyancy by themselves from the inside of the stacked electrode body 6, particularly the portions at which the positive electrode plates 3 and the negative electrode plates 4 at least overlap, in a plurality of “squeeze directions” by means of the “squeeze shape” of the “squeeze section,” and reducing the amount of the air bubbles attached to the corresponding portions. The “squeeze function” is adapted to positively use the movement of the stacked electrode body 6 that is expanded or contracted in the stacked direction (Y direction) by the charge or discharge of the battery 1. This will be described below in detail.

Since a paste of the insulating tape used when the unit is formed is degraded in the electrolyte and so on, as a result, such an insulating tape is loosened in the first battery case. For this reason, in the case of the secondary battery, the positive and negative electrode active materials are not substantially subjected to the influence of the insulating tape by the charge of the battery 1, and the negative electrode active material of each negative electrode plate 4 of the stacked electrode body 6 is expanded in the stacked direction (Y direction) substantially the same extent at any position on the XZ plane.

Accordingly, when an amount of the expansion is increased by the advance of the charge, since the pair of first auxiliary sheets 12 have the “semi-cylindrical” “squeeze shape” as the squeeze section, the respective second surfaces of the pair of first auxiliary sheets 12 are gradually brought into contact with the stacked electrode body 6 from the vicinity of the center of the first battery case on the X axis in two directions, i.e. from the vicinity of the corresponding center toward the ends of the +X and −X sides.

In this case, when the respective first surfaces of the pair of first auxiliary sheets 12 come into contact with the wall surfaces of the first battery case, the first auxiliary sheets 12 no longer move in the Y direction according to the expansion of the stacked electrode body 6. For this reason, when the stacked electrode body 6 continues to be further expanded with the respective first surfaces of the first auxiliary sheets 12 being in contact with the wall surfaces of the first battery case, the stacked electrode body 6 sequentially presses the second surfaces of the first auxiliary sheets 12 from the vicinity of the center of the stacked electrode body 6 on the X axis toward the ends of the ±X directions.

That is, an interval between the second surfaces of the two first auxiliary sheets 12 in the stacked direction (Y direction) is gradually increased from the vicinity of the center of the first battery case on the X axis (or the vicinity of the center of the X axis of the stacked electrode body 6) in the ±X directions. In other words, the distance between the “squeeze sections” in the first battery case in the direction perpendicular to the acting direction of the buoyancy of the air bubbles and in the stacked direction is gradually increased toward the two “squeeze directions.” Accordingly, for this reason, when the negative electrode active material of each negative electrode plate 4 of the stacked electrode body 6 is adapted to be expanded in the stacked direction (Y direction) by the same width at any position on the XZ plane, the stacked electrode body 6 is gradually pressurized from the vicinity of the center of the first battery case by its own expansion force.

That is to say, the battery 1 is configured so that, due to the “squeeze shape” of the first auxiliary sheets 12 that are the “squeeze sections”, a pressure applied between the electrode plates of the stacked electrode body 6 is gradually reduced from the vicinity of the center of the first battery case toward the sidewalls of the first battery case, and so that a value of the pressure is gradually increased by substantially the same amount at any place at which the active materials of the electrode plates are coated.

For this reason, the air bubbles attached to the electrode plates can be effectively squeezed in the two “squeeze directions,” and an amount of the air bubbles attached to the inside of the stacked electrode body 6 can be reduced. Further, the air bubbles are configured to be squeezed in the plurality of “squeeze directions” because the amount of movement of the air bubbles can be reduced compared to the configuration in which the air bubbles are squeezed from one end to the other end of each electrode plate in only one “squeeze direction,” and thus the “squeeze function” can be more effectively exerted.

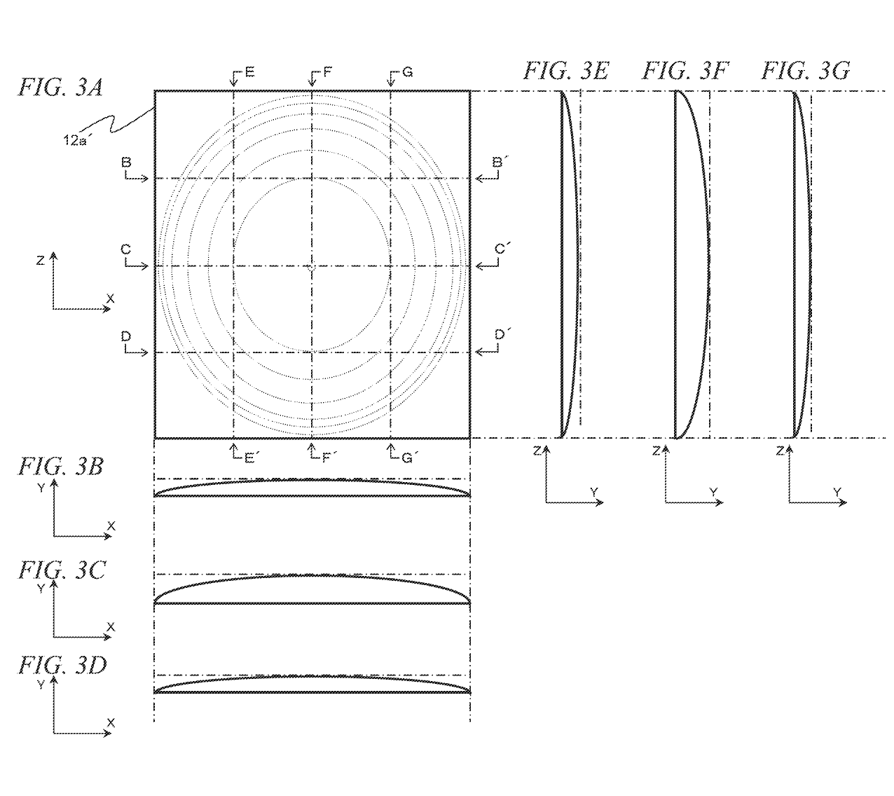

The “squeeze shape” of the second surface of the first auxiliary sheet 12 has been described as being “semi-cylindrical.” However, as shown in FIG. 3A to FIG. 3G the “squeeze shape” may be a “humped shape”. That is, with the advance from the vicinity of the center of the second surface of the approximately rectangular first auxiliary sheet 12 toward the circumference of the first auxiliary sheet 12 in a radial fashion, the second surface may be a shape in which it gradually approaches the first surface (referred to as a “humped shape”). In this case, the other configurations of the battery 1 are the same as the aforementioned configurations. Here, a first auxiliary sheet 12a′ that corresponds to the first auxiliary sheet 12a and has a “squeeze shape” of a “humped shape”, and a first auxiliary sheet 12b′ that corresponds to the first auxiliary sheet 12b and has a “squeeze shape” of a “humped shape” are arranged in the battery 1.

In detail, the first auxiliary sheet 12a′ that has the “squeeze shape” of the “humped shape” will be described using FIG. 3A to FIG. 3G. A configuration of the first auxiliary sheet 12b′ is similar to that of the first auxiliary sheet 12a′, and a description thereof will be omitted here.

FIG. 3A is a layout diagram corresponding to FIG. 2A. A first surface of the first auxiliary sheet 12a′ is a flat surface, but a second surface of the first auxiliary sheet 12a′ has a “humped shape.” As such, for easy understanding, in FIG. 3A, contour lines of Y-directional heights of the second surface are indicated by dotted lines. An XY cross-sectional shape taken along line B-B′ of FIG. 3A is shown in FIG. 3B, an XY cross-sectional shape taken along line C-C′ of FIG. 3A is shown in FIG. 3C, and an XY cross-sectional shape taken along line D-D′ of FIG. 3A is shown in FIG. 3D. Simultaneously, a YZ cross-sectional shape taken along line E-E′ of FIG. 3A is shown in FIG. 3E, a YZ cross-sectional shape taken along line F-F′ of FIG. 3A is shown in FIG. 3F, and a YZ cross-sectional shape taken along line G-G′ of FIG. 3A is shown in FIG. 3G.

As shown in FIGS. 3C to 3F, the first auxiliary sheet 12a′ is designed so that a thickness thereof is thickest at a central portion thereof, and is gradually reduced from the central portion toward the circumference in a radial fashion thereof, as shown in FIGS. 3B, 3D, 3E and 3G.

Accordingly, in the battery 1 of FIG. 1A and FIG. 1B, when the first auxiliary sheet 12a′ is arranged in place of the first auxiliary sheet 12a so that the second surface thereof is directed toward the stacked electrode body 6, and when the first auxiliary sheet 12b′ is arranged in place of the first auxiliary sheet 12b so that the second surface thereof is directed toward the stacked electrode body 6, it is possible to squeeze air bubbles in two directions directed toward the sidewall of the first battery case as well as, including at least the corresponding two directions as “squeeze directions,” in multiple directions more than just the two directions in a radial fashion, like the first auxiliary sheet 12a. In the arrangement of the battery 1 of FIG. 1A and FIG. 1B, the acting direction of gravity has been described as the −Z direction. However, when the battery 1 is allowed to be arranged so that the applying direction of gravity is the +X direction, using the first auxiliary sheets 12a′ and 12b′instead of the first auxiliary sheets 12a and 12b has no influence in the arrangement of the battery 1, that is, the air bubbles can be squeezed even though the wall surface of the first battery case is arranged toward the acting direction of gravity. As such, the performance of the battery can be more effectively improved.

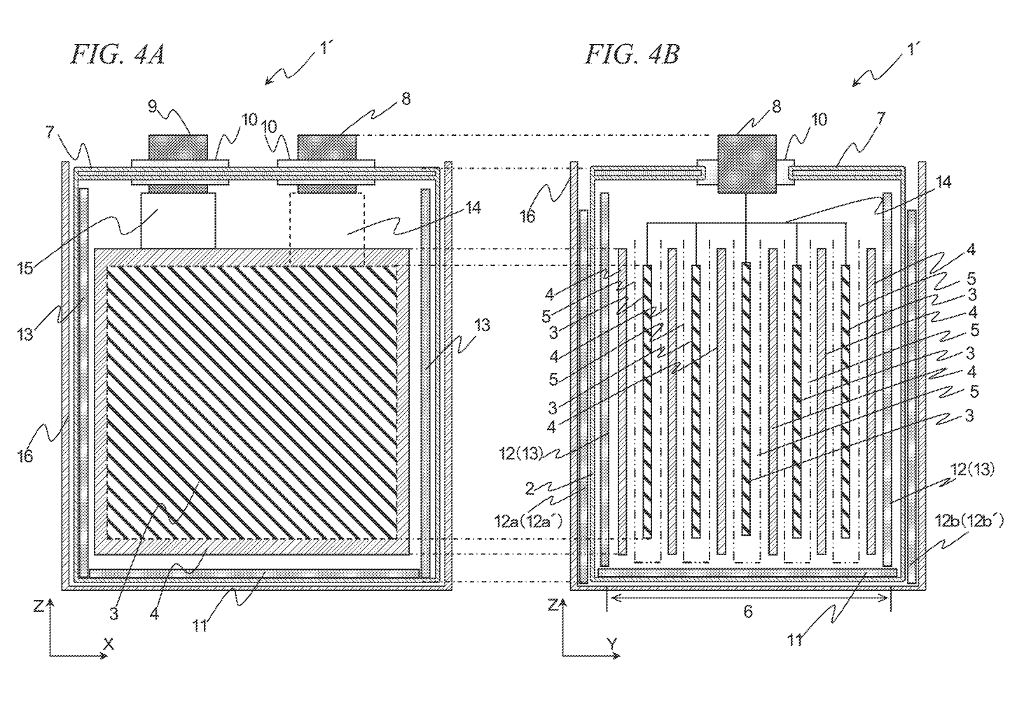

Furthermore, when the first battery case is easily deformed, the battery 1 may be, as shown in FIG. 4A and FIG. 4B, configured to be inserted into a protection case 16 (herein also referred to as “second battery case”) that has substantially the same inner dimensions as the outer dimensions of the first battery case in order to prevent the first battery case from being deformed and from being damaged from the outside. Herein, the battery 1 and the protection case 16 (second battery case) are collected to be defined as a battery 1′. As shown in FIG. 4A, when the XZ plane is viewed from the Y direction, the battery 1′ is designed so that the outer dimensions of the battery 1 and the inner dimensions of the protection case 16 are substantially the same. Further, as shown in FIG. 4B, when the XZ plane is viewed from the X direction, the battery 1′ is designed so that dimensions of the battery 1 in which the first battery case is clamped by a pair of first auxiliary sheets 12 are substantially the same as the inner dimensions of the protection case 16.

The protection case 16, as the second battery case, may hold down and prevent the deformation of the first battery case. As such, the protection case 16 is formed of an insulating resin or a metal having a deformation resistant material and thickness.

According to the configuration of the battery 1′, the battery 1 is sandwiched from the outside of the first battery case by a different pair of first auxiliary sheets 12 in which any one of the same shapes as the pair of first auxiliary sheets 12 inside the battery 1, for instance a “semi-cylindrical shape” and a “humped shape”, is standardized in one shape. Here, second surfaces of the different pair of first auxiliary sheets 12 are arranged toward the first battery case. Accordingly, since the stacked electrode body 6 is sandwiched from the Y direction by four “squeeze sections,” a “squeeze function” is exerted more effectively.

In FIG. 4A and FIG. 4B, the battery 1 itself includes the pair of first auxiliary sheets 12 therein, but a different pair of first auxiliary sheets 12 are arranged outside the first battery case. As such, in place of the pair of first auxiliary sheets 12 inside the battery 1, a pair of second auxiliary sheets 13 may be used. In this case, although a battery inserted into the protection case 16 (second battery case) of the battery 1′ becomes the same as an existing battery, the “squeeze function” is still exerted by the pair of first auxiliary sheets 12 sandwiched from the outside of the first battery case and an inner wall of the protection case 16 (second battery case). Accordingly, since there is no need for the change of design with respect to the battery inserted into the protection case 16 (second battery case), the air bubbles occurring in the stacked electrode body can be squeezed out more easily.

With the simple and easy configuration described above, the air bubbles occurring in the stacked electrode body can be squeezed out. Accordingly, it is possible to provide a battery that promotes removal of the air bubbles occurring in the stacked electrode body, and as a result, improves the battery performance.

In the embodiments and their modifications, only one stacked electrode body 6 is stored in the first battery case. However, a plurality of stacked electrode bodies 6 (herein, stacked electrode bodies 6a and 6b) may be configured so that each of the stacked electrode bodies 6 is formed into a unit similar to that of FIG. 1A and FIG. 1B, and then is stored in the first battery case.

The present invention is not limited to the aforementioned embodiments and a combination thereof. Thus, it will be appreciated that various modifications and changes can be made without departing from the spirit and scope of the present invention. For example, although the shape of the first battery case is described as a square shape, the battery case may be a cylindrical shape. Similarly, the stacked electrode body 6 may be a stacked electrode body (i.e. a stacked-type stacked electrode body) in which a plurality of positive electrode plates and a plurality of negative electrode plates are sequentially stacked with respective separators in between or may be a stacked electrode body (i.e. a winding-type stacked electrode body) in which one positive electrode plate and one negative electrode plate with one separator interposed between them and in which they are wound.

Further, the first battery case has been described as the conductive material, but an insulating material such as a plastic resin may also be used. Even when the first battery case is formed of an insulating material, the auxiliary sheets of the first auxiliary sheets 12 or the second auxiliary sheets 13 serving as the insertion guides are very useful in order to store the stacked electrode body 6 in the first battery case without damage.

Furthermore, when the function as the insertion guide may be of little account because the dimensions of the first battery case are great compared to those of the stacked electrode body 6, the shape corresponding to the “squeeze shape” which the first auxiliary sheet 12 as the squeeze section has may be integrally formed of the same material, for instance, by a mold and so on as the inner wall of the first battery case in case the first battery case is formed. In this case, the inner wall itself becomes the “squeeze section.” Of course, like the first auxiliary sheet 12, it may be formed separately from the first battery case. Similarly, the shape corresponding to the “squeeze shape” of the first auxiliary sheet 12 may be integrally formed of the same material for the inner wall of the protection case 16 (second battery case) using a mold and so on. In this case, the inner wall itself becomes the “squeeze section.”

In addition, to smooth the flows of the air bubbles and the electrolyte, the first auxiliary sheet 12 may be provided with through-holes running from the first surface to the second surface, and recessed shaped grooves in the first surface which extend in a gravitational direction.

### DESCRIPTION OF REFERENCE NUMERALS

1: battery,
2: case body,
3: positive electrode plate,
4: negative electrode plate,
5: separator,
6: stacked electrode body,
7: cap,
8: positive terminal,
9: negative terminal,
10: insulating resin,
11: insulating resin plate,
12 (12a, 12b, 12a′, 12b′): first auxiliary sheet,
13: second auxiliary sheet,
14: positive electrode tab,
15: negative electrode tab,
16: protection case (second battery case)

What is claimed is:

1. A battery comprising:
a stacked electrode body formed by stacking a first electrode plate and a second electrode plate through a separator;
an electrolytic solution or an electrolyte;
a battery case that has a first electrode terminal electrically connected to the first electrode plate and a second electrode terminal electrically connected to the second electrode plate and that stores the electrolytic solution or the electrolyte and the stacked electrode body; and
a squeeze section, which is located between the stacked electrode body and the battery case and is formed as one body the battery case or separately from the battery case, and in which a thickness thereof is reduced toward each of a plurality of squeeze directions.

2. The battery according to claim 1, wherein
the squeeze shape of the squeeze section is a semi-cylindrical shape.

3. The battery according to claim 1, wherein
the squeeze shape of the squeeze section is a humped shape.

4. The battery according to claim 2, wherein
the squeeze section is an insulating auxiliary sheet formed separately from the battery case and promotes squeezing and raising air bubbles occurring inside the stacked electrode body by a volume change of the stacked electrode body associated with charge or discharge of the battery.

5. The battery according to claim 3, wherein
the squeeze section is an insulating auxiliary sheet formed separately from of the battery case and promotes squeezing and raising air bubbles occurring inside the stacked electrode body by a volume change of the stacked electrode body associated with charge or discharge of the battery.

6. The battery according to claim 4, wherein
the first electrode plate is a positive electrode plate;
the second electrode plate is a negative electrode plate;
the first electrode terminal is a positive electrode terminal;
the second electrode terminal is a negative electrode terminal; and
the battery case is a protection case.

7. The battery according to claim 5, wherein
the first electrode plate is a positive electrode plate;
the second electrode plate is a negative electrode plate;
the first electrode terminal is a positive electrode terminal;
the second electrode terminal is a negative electrode terminal; and
the battery case is a protection case.

8. The battery according to claim 2, wherein
the squeeze section is formed as one body with the battery case and promotes squeezing and raising air bubbles occurring in the stacked electrode body by a volume change of the stacked electrode body associated with charge or discharge of the battery.

9. The battery according to claim 3, wherein
the squeeze section is formed as one body with the battery case and promotes squeezing and raising air bubbles occurring in the stacked electrode body by a volume change of the stacked electrode body associated with charge or discharge of the battery.

10. The battery according to claim 8, wherein
the first electrode plate is a positive electrode plate;
the second electrode plate is a negative electrode plate;
the first electrode terminal is a positive electrode terminal;
the second electrode terminal is a negative electrode terminal; and
the battery case is a protection case.

11. The battery according to claim 9, wherein
the first electrode plate is a positive electrode plate;
the second electrode plate is a negative electrode plate;
the first electrode terminal is a positive electrode terminal;
the second electrode terminal is a negative electrode terminal; and
the battery case is a protection case.
